(19) United States
(12) Patent Application Publication
(10) Pub. No.: US 2026/0100468 A1
(43) Pub. Date: Apr. 9, 2026

(54) INTRINSICALLY SAFE BATTERY ASSEMBLY

(71) Applicant: AKTIEBOLAGET SKF, GOTEBORG (SE)

(72) Inventors: Xuejun WEN, Shanghai (CN); Jinbao ZHANG, Kunshan (CN); Liyao GUO, Shanghai (CN); Qin HAN, Shangai (CN); Bo HAN, Shanghai (CN)

(21) Appl. No.: 19/342,782

(22) Filed: Sep. 29, 2025

(30) Foreign Application Priority Data
Oct. 8, 2024 (CN) 202422410159.2

(51) Int. Cl. H01M 50/284; F16N 13/06; H01M 10/058; H01M 10/42; H01M 50/213; H01M 50/298; H02J 7/00

(52) U.S. Cl. CPC H01M 50/284; F16N 13/06; H01M 10/058; H01M 10/4257; H01M 50/213; H01M 50/298; H02J 7/68; F16N 2013/063; H01M 2200/103

(57) ABSTRACT

An intrinsically safe battery assembly includes a battery pack including at least one battery and a protection circuit connected in series with the battery pack. The protection circuit includes the following elements connected in series: at least one diode configured to prevent the battery pack from being reversely charged, at least one current limiting resistor configured to provide short circuit protection and a resettable fuse configured to provide over current protection.

### CROSS-REFERENCE

This application claims priority to Chinese patent application no. 202422410159.2 filed on Oct. 8, 2024, the contents of which are fully incorporated herein by reference.

### TECHNOLOGICAL FIELD

The disclosure relates to an intrinsically safe battery assembly, and is described in conjunction with the application of the intrinsically safe battery assembly in a single-point lubricator.

### BACKGROUND

A single-point lubricator is designed to automatically deliver a correct dose of a lubricant (lubricating grease or lubricating oil) onto a given lubrication point. Compared to traditional manual lubrication techniques, the single-point lubricator may more accurately control the supply quantity and supply time of the lubricant. Since the single-point lubricator comprises a drive electric motor and a battery assembly providing power to an electric mechanism, it must meet the standards of intrinsically safe electrical appliances before it can be used in underground environments such as coal mines or the like. The description “intrinsically safe” means that the production equipment has safe performance through means such as design or the like, that will not cause accidents even in the case of mis-operation or malfunction. The characteristic of intrinsically safe electrical appliances is that all circuits thereof are intrinsically safe circuits, that is, under normal operation or under specified conditions, the electrical sparks and thermal effects generated by the circuits cannot ignite specified explosive mixtures.

Reality calls for a battery assembly that meets the requirements of intrinsically safe electrical appliances and thus can be used even in explosive environments, as well as a single-point lubricator that uses the battery assembly.

### SUMMARY

In order to meet the above requirements, the present disclosure provides an intrinsically safe battery assembly comprising a battery pack including at least one battery and a protection circuit connected in series with the battery pack, the protection circuit comprising the following devices connected in series: a diode for preventing the battery pack from being reversely charged, a current limiting resistor for providing short circuit protection, and a resettable fuse for providing over current protection.

The protection circuit is able to eliminate the safety hazards in which over current, short circuit and reverse charging, or the like may cause electrical sparks and thermal effects, thus it is able to avoid the possibility of explosive mixtures being ignited to the greatest extent.

On the basis of the intrinsically safe battery assembly described above, the present disclosure also provides a single-point lubricator comprising a reservoir for storing lubricant and a power compartment for accommodating power components. The reservoir and the power compartment are configured to be assembled as one piece with each other in a detachable manner. The power components comprise an electric motor and the intrinsically safe battery assembly described above providing power to the electric motor. The motor is provided to drive a pumping mechanism for squeezing the lubricant in the reservoir out of an oil outlet.

Since the intrinsically safe battery assembly gives the single-point lubricator intrinsic safety performance in terms of power supply, the latter is allowed to be used in underground flammable and explosive atmosphere environments such as coal mines or the like.

### BRIEF DESCRIPTION OF THE DRAWINGS

FIG. 1 is a circuit diagram of a battery assembly according to an embodiment of the present disclosure.

FIG. 2A is a perspective view of the battery assembly of the present disclosure.

FIG. 2B is a sectional view of the battery assembly of FIG. 2A.

FIG. 3A is a sectional side elevational view of a power compartment.

FIG. 3B is a sectional elevational view taken along line A-A in FIG. 3A.

FIG. 3C is a sectional plan view of the power compartment of FIG. 3A.

FIG. 4 is a sectional elevational view of a reservoir.

### DETAILED DESCRIPTION

In the following description, identical or similar reference numerals are always used to denote the same or similar components. Terms indicating directions, for example, “axial”, “radial” and “circumferential (direction)”, refer to the axial, radial and circumferential (direction) of the component being described, unless otherwise defined or specified.

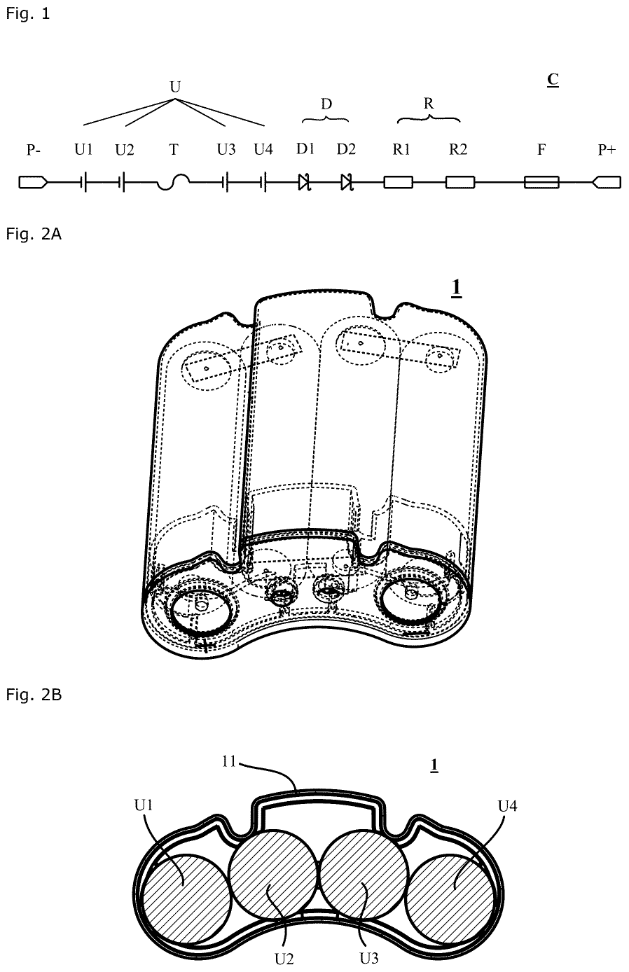

FIG. 1 shows a circuit diagram of the intrinsically safe battery assembly of the present disclosure. It can be seen from the figure that, a battery assembly 1 comprises a battery pack U having at least one battery, in this case first, second, third and fourth batteries U1, U2, U3, U4 and a protection circuit C forming a series connection with the battery pack U. In the illustrated embodiment, the batteries U1, U2, U3, U4 are zinc/manganese dioxide batteries connected in series, and the protection circuit C includes a diode D, a current limiting resistor R, a resettable fuse F, and a thermistor T connected in series between the second battery U2 and the third battery U3. The design concepts and functions of these electrical components are described in detail below in conjunction with the accompanying drawings.

In the protection circuit C, the diode D is used to prevent the battery pack U from being reversely charged. The so-called “reverse charging” refers to the phenomenon in which an individual battery in a series battery pack is charged when a current flows in a forward direction (i.e., the battery pack outputs power) due to reverse polarity. There are two common reasons for reverse polarity of battery: one is that the polarity of individual battery is opposite to the overall polarity of the battery pack (due to mis-assembly), and the other is that the positive potential of individual battery therein is lower than the negative potential thereof, due to over-discharge (energy exhaustion) of the battery pack. If the reverse polarity of the battery is not corrected in time, it may cause battery failure or even explosion accidents. When the current flows reversely in the protection circuit C, the diode D is in a blocking state and can withstand a sufficiently high reverse bias voltage, thus ensuring that the battery pack U is not reversely charged.

In the illustrated embodiment, the diode D comprises two Schottky diodes D1 and D2 connected in series. If one of the diodes fails, the other diode can still act to stop the current from flowing in a reverse direction. Considering that the diode has a forward conduction voltage drop (abbreviated as “conduction voltage drop”), two diodes being connected in series will produce double conduction voltage drop. Taking a silicon diode as an example, its conduction voltage drop is about 0.7V. In a case of adopting two diodes connected in series, the cumulative conduction voltage drop may reach about 1.4V. In a case where four 1.5V batteries are connected in series to form a 6V power supply, the conduction voltage drop of 1.4V will obviously significantly reduce the voltage input that a load circuit (the circuit between P+ and P−, not shown) can obtain. For this purpose, the present disclosure adopts two Schottky diodes D1 and D2 connected in series. The conduction voltage drop of a single Schottky diode is only about 0.15 to 0.45V, so the two Schottky diodes D1 and D2 connected in series can significantly enhance the output voltage and the voltage utilization of the battery pack U.

The purpose of providing the current limiting resistor R in the protection circuit C is to ensure that, if a short circuit occurs in the load circuit, the short circuit current can still meet the requirements of intrinsically safe electrical appliances and is limited to the maximum current range that the battery pack U can withstand. In the specific embodiment shown in FIG. 1, the current limiting resistor R is formed from two equivalent resistors R1 and R2 connected in series. This is because, compared to a single resistor, two resistors in series can share power consumption, improve heat dissipation and simultaneously also reduce the risk of the short circuit occurring in one separate resistor. In addition, the two small power resistors make it easier to meet the packaging requirements of the battery assembly and even reduce a size of a housing of the battery assembly. As a preferred embodiment, the current limiting resistors R1 and R2 are surface-mounted alloy resistors soldered onto the circuit board by tin soldering. The surface-mounted alloy resistors have the characteristics of high thermal conductivity, high heat resistance and low temperature drift, and still have stability and safety even in the case of the heating of a high power.

In addition to the current limiting resistor R, the protection circuit C further includes the resettable fuse F for over current protection. The resettable fuse is a polymeric positive temperature coefficient device (PPTC), of which the rated current is provided as a value obtained by multiplying the maximum working current of the load circuit by the safety factor, for example, 1.7. When the load current reaches the rated current of the fuse, the fuse will blow, thereby cutting off the power supply. After the malfunction is eliminated, the fuse automatically recovers, allowing the current to pass through again. Compared with an ordinary fuse, the resettable fuse may be operated repeatedly without manual replacement, thus having the advantages of high reliability, good economy and long lifespan.

The protection circuit C also comprises at least one thermistor T connected in series between two of the batteries U1-U4. As a positive temperature coefficient device, the thermistor T can provide timely protection such as short circuit, over current, temperature rise control, or the like, when the protection circuit C fails or the battery overheats. Even in the case of over-discharge, reverse polarity or short circuit of the battery, it will not cause accidents such as battery damage, combustion and explosion. In the illustrated embodiment, the thermistor Tis connected in series between the second battery U2 and the third battery U3. When battery pack U comprises an odd number of batteries, the thermistor T is connected near the center of the series connected batteries.

In the present disclosure, the above electrical components of the protection circuit C are all integrated on one circuit board (not shown), and are potted in the housing 11 of the battery assembly 1 together with the battery pack U. FIG. 2A and FIG. 2B show the structural schematic views of the battery assembly in different perspectives. It can be seen from the figures that, the battery assembly 1 is formed into a substantially circular arc cuboid, which is suitable for assembly in a substantially cylindrical power compartment of a single-point lubricator, as described in detail below.

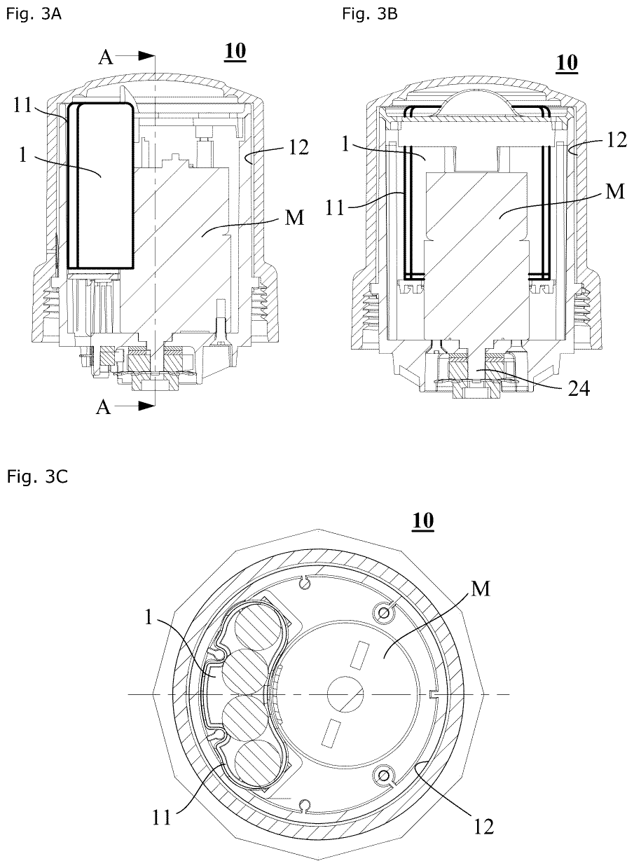

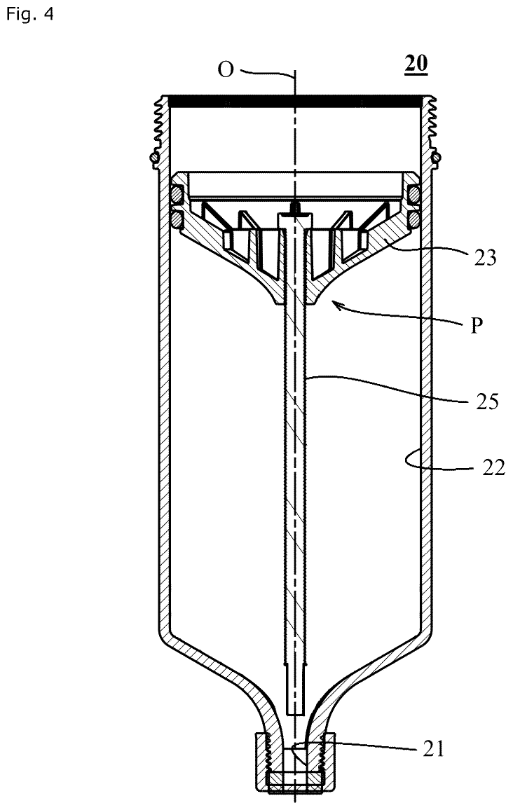

As shown in FIG. 3 and FIG. 4, a single-point lubricator is formed by detachably connecting a power module 10 to a reservoir 20. The power module 10 is used to accommodate power components, and the reservoir 20 is used to store a lubricant. The power components comprise an electric motor M and the battery assembly 1 providing power to the electric motor M. The electric motor M is used to drive a pumping mechanism P for squeezing the lubricant in the reservoir 20 out of an oil outlet 21. The internal structures of the power compartment 10 and the reservoir 20 are described in detail below in conjunction with FIG. 3 and FIG. 4.

FIG. 3A, FIG. 3B and FIG. 3C show the structural schematic views of the power compartment in different perspectives. It can be seen from the figures that the battery assembly 1 of the substantially circular arc cuboid shape is provided between a cylindrical inner wall 12 of the power compartment 10 and the electric motor M. It fits the inner wall 12 of the power compartment 10 on the radially outer side, and encloses the electric motor M on the radially inner side. It can be further seen from FIG. 3A that the electric motor M (the housing thereof) is disposed eccentrically inside the power compartment 10, at least partially yielding a radial space required by the battery assembly 1. This feature, together with the circular arc cuboid shape of the battery assembly 1, improves the space utilization of the power compartment 10 to the greatest extent. In other words, the combination of the features described above facilitates the power compartment to accommodate as many power components (the electric motor and the battery assembly) as possible with minimal structural size and manufacturing cost.

FIG. 4 shows a cross-sectional schematic view of the reservoir in a radial perspective. It can be seen from the figure that, a cylindrical side wall 22 of the reservoir 20 forms a hydraulic cylinder, and a piston 23 forms a sliding sealing fit with the cylindrical side wall 22, which is used to squeeze the lubricant in the reservoir 20 out of the oil outlet 21 below under the drive of the electric motor M. A rotating shaft 24 of the electric motor M is connected with a lead screw 25, the latter converts the torque output from the rotating shaft 24 into the power for the piston 23 propelling inside the reservoir 20, by cooperation with the thread of the piston 23. As a preferred embodiment, the rotating shaft 24 of the electric motor M (together with the lead screw 25) is radially approximately at a geometric center O of the reservoir 20.

The single-point lubricator described by the present disclosure may also realize remote condition monitoring and control through wireless connection. For example, the single-point lubricator may be connected to a remote monitoring platform (not shown) of the lubricator through a Low-Power Wide-Area Network NB (Narrow Band) or Lora gateway.

The intrinsically safe battery assembly and the application thereof in the single-point lubricator described above are not limited by the specific embodiments and more general technical solutions will be subject to the limitations of the accompanying claims. Any modifications and improvements to the present disclosure are within the scope of protection of the present disclosure, provided they conform to the limitations of the accompanying claims.

What is claimed is:

1. An intrinsically safe battery assembly comprising:
a battery pack including at least one battery; and
a protection circuit connected in series with the battery pack, the protection circuit comprising the following elements connected in series:
at least one diode configured to prevent the battery pack from being reversely charged;
at least one current limiting resistor configured to provide short circuit protection; and
a resettable fuse configured to provide over current protection.

2. The intrinsically safe battery assembly according to claim 1,
wherein the at least one diode comprises two Schottky diodes connected in series.

3. The intrinsically safe battery assembly according to claim 1,
wherein the at least one current limiting resistor comprises two equivalent resistors connected in series.

4. The intrinsically safe battery assembly according to claim 1,
wherein the at least one battery comprise a first battery connected in series to a second battery, and
wherein the protection circuit further comprises a thermistor connected in series between the first battery and the second battery.

5. The intrinsically safe battery assembly according to claim 4,
wherein the elements connected in series are mounted on a circuit board and potted in a housing of the battery assembly together with the battery pack.

6. The intrinsically safe battery assembly according to claim 5,
wherein the batteries are zinc/manganese dioxide batteries.

7. A single-point lubricator comprising:
a reservoir configured to store a lubricant,
a power module containing power components, and
a pumping mechanism configured to pump the lubricant in the reservoir out of an oil outlet,
wherein the power module is detachably connected to the reservoir,
wherein the power components include an electric motor and the intrinsically safe battery assembly according to claim 1, and
wherein the battery assembly is electrically connected to the motor

8. The single-point lubricator according to claim 7,
wherein the battery assembly forms a substantially circular arc cuboid and is assembled between the electric motor and a substantially cylindrical inner wall of compartment inside the power module, the battery assembly fitting the inner wall of the compartment on a radially outer side and facing the electric motor on a radially inner side.

9. The single-point lubricator according to claim 8,
wherein the electric motor is disposed eccentrically inside the power module to provide a radial space for the battery assembly inside the power module, and
wherein a rotating shaft of the electric motor is centrally located inside the reservoir.

10. The single-point lubricator according to claim 8,
wherein the pumping mechanism comprises a hydraulic cylinder formed by a cylindrical side wall of the reservoir and a piston forming a sliding sealing fit with the side wall, the rotating shaft of the electric motor being configured to drive the piston to squeeze the lubricant in the reservoir via screw fit between a lead screw and the piston.
